(19) United States
(12) Patent Application Publication
(10) Pub. No.: US 2009/0037880 A1
(43) Pub. Date: Feb. 5, 2009

(54) SYSTEM, METHOD, AND COMPUTER PROGRAM PRODUCT FOR CONFIGURING A GOAL

(76) Inventors: John Bailey Adger III, San Francisco, CA (US); Robert R. Bernshteyn, Foster City, CA (US); Max S. Goldman, San Francisco, CA (US); David T. Madden, Boston, MA (US)

Correspondence Address: Zilka-Kotab, PC, P.O. BOX 721120, SAN JOSE, CA, 95172-1120, US

(21) Appl. No.: 11/833,064

(22) Filed: Aug. 2, 2007

(51) Int. Cl. G06F 9/44

(52) U.S. Cl. 717/121

(57) ABSTRACT

A system, method, and computer program product are provided for configuring a goal. Information associated with different aspects of a goal is received utilizing a plurality of graphical user interfaces. In use, a previous one of the graphical user interfaces progresses to a subsequent one of the graphical user interfaces only after receiving the information associated with the aspect associated with the previous one of the graphical user interfaces. To this end, the goal is configured utilizing such information.

### FIELD OF THE INVENTION

The present invention relates to software, and more particularly to goal configuration software.

### BACKGROUND

Traditionally, goals have beers used for identifying objectives of people, organizations, etc. Oftentimes, the “SMART” goal framework is used to configure goals. SMART goals include certain aspects—namely, SMART goals must be specific (“S”), measurable (“M”), attainable (“A”), relevant (“R”), and time-bound (“T”). To date, software applications utilized to configure goals have conventionally been limited in various respects.

There is thus a need for addressing these and/or other issues associated with the prior art.

### SUMMARY

A system, method, and computer program product are provided for configuring a goal. Information associated with different aspects of a goal is received utilizing a plurality of graphical user interfaces. In use, a previous one of the graphical user interfaces progresses to a subsequent one of the graphical user interfaces only after receiving the information associated with the aspect associated with the previous one of the graphical user interfaces. To this end, the goal is configured utilizing such information.

### BRIEF DESCRIPTION OF THE DRAWINGS

FIG. 1 shows a method for configuring a goal, in accordance with one embodiment.

FIG. 2 shows a method for progressively receiving information associated with different aspects of a goal, in accordance with another embodiment.

FIG. 3 shows a graphical user interface (GUI) for receiving information associated with a “specific” aspect of a goal from a library of goals, in accordance with yet another embodiment.

FIG. 4 shows a GUI for receiving information associated with a “measurable” aspect of a goal, in accordance with still yet another embodiment.

FIG. 5 shows a GUI for receiving information associated with an “attainable” aspect of a goal, in accordance with another embodiment.

FIGS. 6A-B show a GUI for receiving information associated with a “relevancy” aspect of a goal, in accordance with yet another embodiment.

FIG. 7 shows a GUI for receiving information associated with a “time” aspect of a goal, in accordance with still yet another embodiment.

FIG. 8 shows a GUI for prompting the receipt of additional details of a goal, in accordance with another embodiment.

FIG. 9 shows a GUI for receiving additional details of a goal, in accordance with yet another embodiment.

FIG. 10 shows a GUI for displaying and managing a user's goals, including assigning a goal to a plurality of different people, in accordance with yet another embodiment.

FIG. 11 shows a GUI for displaying reports associated with a plurality of goals, in accordance with still yet another embodiment.

FIG. 12 shows a GUI for displaying a report associated with each goal, in accordance with another embodiment.

FIG. 13 illustrates a performance and talent management system, in accordance with one embodiment.

FIG. 14 illustrates a network architecture, in accordance with one embodiment.

FIG. 15 illustrates an exemplary computer system, in accordance with one embodiment.

### DETAILED DESCRIPTION

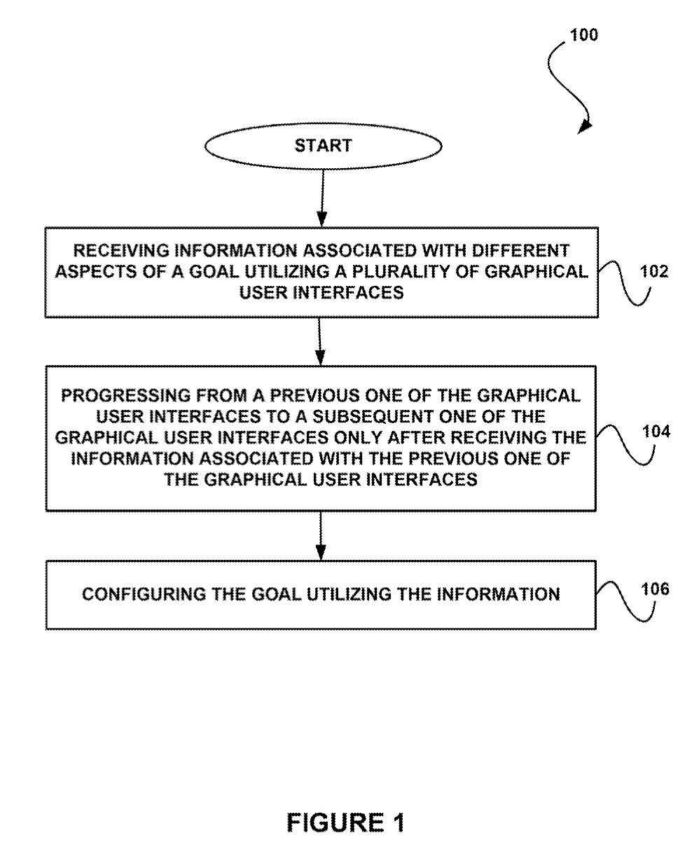

FIG. 1 shows a method 100 for configuring a goal, in accordance with one embodiment. As shown in operation 102, information associated with different aspects of a goal is received utilizing a plurality of graphical user interfaces (GUIs). In the context of the present embodiment, the goal is any desired objective that includes different aspects. Just by way of example, in various embodiments, the goal may be a personal objective, a group objective, a business objective, etc. To this end, in different embodiments, the goal may be a personal goal, a goal of a group, a goal of an organization, and/or any other type of goal, for that matter.

In one optional embodiment, the goal may be configured in the context of a performance and talent management application program (e.g. employee performance and talent management application program, etc.). Thus, in the following description, some of the details set forth may or may not be relevant to such specific environment. It should be strongly noted, however, that such details should not be construed as limiting in any manner whatsoever, since the goal may be configured in the context of absolutely any desired environment.

In various embodiments, the different aspects of the goal may include any number of different aspects. In one embodiment, at least one of the aspects may be a “specific” aspect. Optionally, the information associated with the “specific” aspect may be a category of the goal. Just by way of example, the category may be an administration category, a corporate services category, a customer service category, a sales category, and/or any other category capable of being associated with a goal.

As another option, the information associated with the “specific” aspect may be a specific description of an aim of the goal, as opposed to something that is nebulous or vague. For example, such description may include an amount of sales to be achieved in association with the goal, development of a particular application to be achieved in association with the goal, etc. Of course, it should be noted that the “specific” aspect may include anything that is specific to the goal.

In another embodiment, at least one of the aspects may be a “measurable” aspect. As an option, the information associated with the “measurable” aspect may be any criteria for determining whether the goal has been accomplished in full or the extent to which the goal has been accomplished. For example, the information associated with the “measurable” aspect may be utilized for determining a percentage of accomplishment (e.g. completion) of the goal. To this end, the information associated with the “measurable” aspect may be used in conjunction with a tool for determining whether the goal is being accomplished, etc.

In yet another embodiment, at least one of the aspects may be an “attainable” aspect. The information associated with the “attainable” aspect may include an indication as to whether the goal is capable of being achieved. For example, the information associated with the “attainable” aspect may be a selection of various options (e.g. a “yes” option, a “no” option, etc.) for identifying whether the goal is attainable.

In still yet another embodiment, at least one of the aspects may be a “relevancy” aspect. As an option, the information associated with the “relevancy” aspect may include an indication as to whether the goal is relevant. For example, the information associated with the “relevancy” aspect may be a selection of various options (e.g. a “yes” option, a “no” option) for identifying whether the goal is relevant. As an option, the goal may be relevant if the goal is aligned with another goal (e.g. a manager's goal, a company goal, etc.). Just by way of example, the goal may be relevant if the goal is a sub-goal of another goal (e.g. of a user or of a manager's or company's goal, etc.).

In yet another embodiment, at least one of the aspects may be a “time” aspect. Moreover, the information associated with the “time” aspect may include a start time and/or a completion time associated with the goal. Just by way of example, the start time may be a date when efforts toward attainment of the goal are commenced, and the completion time may be a date by when the goal should be attained.

Thus, in one embodiment, the goal may be a “SMART” goal, where the aspects associated therewith include a “specific” aspect, a “measurable” aspect, an “attainable” aspect, a “relevancy” aspect, and a “time” aspect. Of course, in other embodiments, the goal may be associated with any different aspects, as desired. As an option, in various other embodiments, the goal may be associated with additional details, such as persons to whom the goal is associated (e.g. who are responsible for achievement of the goal, etc.), groups to which the goal is associated, etc.

Furthermore, the information associated with the different aspects of the goal may be received in any manner utilizing the GUIs. In one embodiment, the GUIs may include windows. It should be noted that the GUIs may also include any GUIs capable of being utilized to receive information associated with the different aspects of the goal.

Still yet, the information associated with the different aspects of the goal may be received from a user utilizing the GUIs. For example, the user may input the information via the GUIs. As another option, the user may select the information via the GUIs. Just by way of example, the information associated with the “specific” aspect of the goal may be received from a user selecting at least one of a plurality of predefined goals. Such predefined goals may be stored in a library, in one embodiment. As yet another example, predefined options may be displayed for selection when configuring a certain aspect of a goal based on how another aspect of such goal was previously configured.

As yet another option, the information associated with the different aspects of the goal may be received from a client by an application program installed on a server, utilizing a network. For example, the application program may thus be a web-based program. In other embodiments, information associated with different aspects of a plurality of goals may be received at the server from various clients over the network. Of course, client-based implementations are also contemplated.

In use, a previous one of GUIs progresses to a subsequent one of the GUIs only after receiving the information associated with the previous one of the GUIs, as shown in operation 104. In one embodiment, each of the GUIs may be associated with at least one of the aspects of the goal. Thus, each of the GUIs may be utilized for receiving information associated with one of the aspects of the goal. Of course, it should be noted that each of the GUIs may be associated with any number of aspects of the goal.

Further, in one optional embodiment, the GUIs may include a predefined sequence of GUIs. Thus, display of a first one of the GUIs may be followed by display of a second one of the GUIs, and so forth. Also, the previous one of the GUIs may progress to a subsequent one of the GUIs only after receiving the information associated with the previous GUI, such that each GUI may only be displayed in response to receipt of information associated with the previous GUI.

In this way, information associated with one aspect of the goal may be required prior to prompting for information associated with a subsequent aspect of the goal. Consequently, a user may optionally be required to provide information for each of the aspects of the goal, in sequence.

Of course, it should be noted that progressing to a subsequent one of the GUIs only after receiving the information associated with the previous one of the GUIs is set forth as an optional embodiment, and that other embodiments are also contemplated. For example, a subsequent one of the GUIs may be progressed to without receiving the information associated with the previous one of the GUIs. For example, information associated with each of the aspects of the goal may be received in any desired sequence (e.g. selected by the user, etc.).

To this end, the goal is configured utilizing the information, as shown in operation 106. In one embodiment, the goal may be configured by creating, modifying, etc. the goal. In another embodiment, the goal may be configured by associating the information associated with each of the aspects of the goal with an identifier (e.g. unique goat identifier such as a goal name, etc.) corresponding to the goal. As an option, configuration of the goal may only be completed in response to receipt of information associated with each aspect of the goal.

As mentioned earlier, the goal may be configured for use in a performance and talent management application program, in one embodiment. For example, the goal may be utilized in conjunction with identifying, tracking, measuring, etc. performance of any employee associated with the goal.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

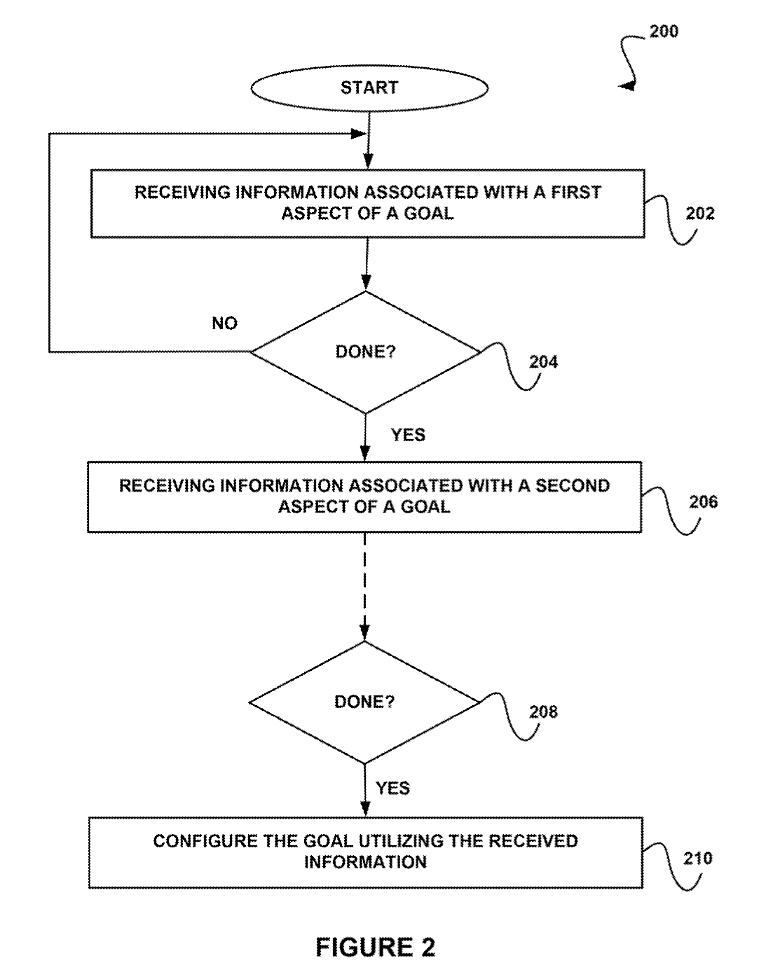

FIG. 2 shows a method 200 for progressively receiving information associated with different aspects of a goal, in accordance with another embodiment. As an option, the method 200 may be carried out in the context of the details of FIG. 1. Of course, however, the method 200 may be implemented in any desired environment. Further, the aforementioned definitions may equally apply to the description, below.

As shown in operation 202, information associated with a first aspect of a goal is received. In one embodiment, the first aspect of the goal may be an initial aspect of the goal included within a predefined sequence of different goal aspects. Just by way of example, the first aspect of the goal may be a “specific” aspect of the goal.

In addition, information associated with the first aspect of the goal may be received utilizing a first GUI associated with the first aspect of the goal. As an option, the first GUI may be specific to the first aspect of the goal. In various embodiments, the first GUI may allow a user to input and/or select the information associated with the first aspect of the goal.

As also shown, it is determined in decision 204 whether the information associated with the first aspect of the goal has been received. For example, it may be determined whether a user has input the information associated with the first aspect of the goal via the first GUI. In another embodiment, it may be determined whether the user has selected a button in order to submit the information associated with the first aspect of the goal such that information associated with another aspect of the goal may then be received. For example, the decision 204 may be made in response to a user selection to progress to a second GUI associated with a second aspect of the goal.

In response to a determination that the information associated with the first aspect of the goal has been received, information associated with a second aspect of the goal is received. Note operation 206. In one embodiment, the second aspect of the goal may be a second aspect of the goal within the predefined sequence of different goal aspects. In another embodiment, the second aspect of the goal may be a “measurable” aspect of the goal.

As an example, the information associated with the second aspect of the goal may be received utilizing a second GUI associated with the second aspect of the goal. To this end, the second GUI may optionally be specific to the second aspect of the goal, and may further allow a user to input and/or select the information associated with the second aspect of the goal.

Similarly, information associated with each subsequent aspect of the goal is received in sequence, in response to a determination that information associated with a previous aspect of the goal has been received. In response to a determination that information associated with a last aspect of the goal has been received (see decision 208), the goal is configured utilizing the information associated with each of the different aspects of the goal. Note operation 210. In this way, it may be ensured that configuration of the goal is based on information received for all aspects of the goal.

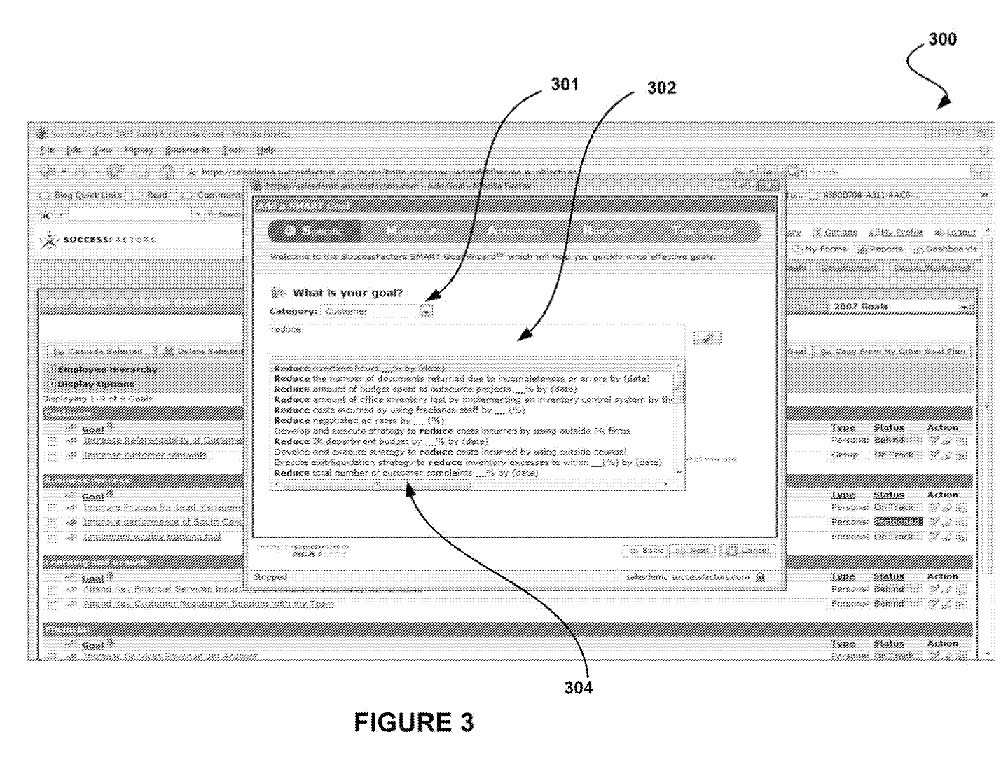

FIG. 3 shows a GUI 300 for receiving information associated with a “specific” aspect of a goal from a library of goals, in accordance with yet another embodiment. As an option, the GUI 300 may be implemented in the context of the details of FIGS. 1 and/or 2. For example, the GUI 300 may be utilized for receiving information in association with operation 102 of FIG. 1 and/or operations 202, 206, 210, etc. of FIG. 2. Of course, however, the GUI 300 may be implemented in any desired environment. Further, the aforementioned definitions may equally apply to the description below.

As shown, the GUI 300 is a window via which information associated with a “specific” aspect of a goal may be received. A drop down list of categories 301 of goals is displayed, such that selection of one of the categories 301 results in a display of sub-categories 304 of goals. Thus, each of the categories 301 of goals may be expanded to display sub-categories 304 of goals.

In one embodiment, the categories 301 may include any categories capable of being associated with a goal. Just by way of example only, the categories 301 may include an administration category, a corporate services category, etc. In addition, the sub-categories 304 may each include a “specific” aspect of a goal. Thus, as an option, the sub-categories 304 may be representative of a library of various predefined goals. Just by way of example, the sub-categories 304 may include the development of specific applications, sales targets, etc.

To this end, as shown, the GUI 300 may allow a library of predefined goals 304, which may categorized into various sub-categories, to be displayed. Further, the GUI 300 may also allow selection by a user of at least one of the goals 304. Moreover, as also shown, a text field 302 may allow the user to input a keyword, phrase, etc. capable of identifying at least one of the goals 304. Just by way of example, the input to the text field 302 may be utilized to search the goals 304 to identify and display identifiers, names, content, etc. of goals 304 that match the input, at least in part.

In this way, the user may select information associated with a “specific” aspect of a goal by selecting at least one of a plurality of predefined goals within the library. As an option, the GUI 300 may also include buttons for submitting the “specific” aspect. For example, one of such buttons may be a button for submitting a selected “specific” aspect and progressing to a next GUI.

Of course, it should be noted that while a library of predefined goals 304 is described herein, in other embodiments, other GUIs may allow the user to manually input information associated with the “specific” aspect of the goal. In this way, the user need not necessarily be limited to selecting a “specific” aspect of a goal from a library of predefined goals.

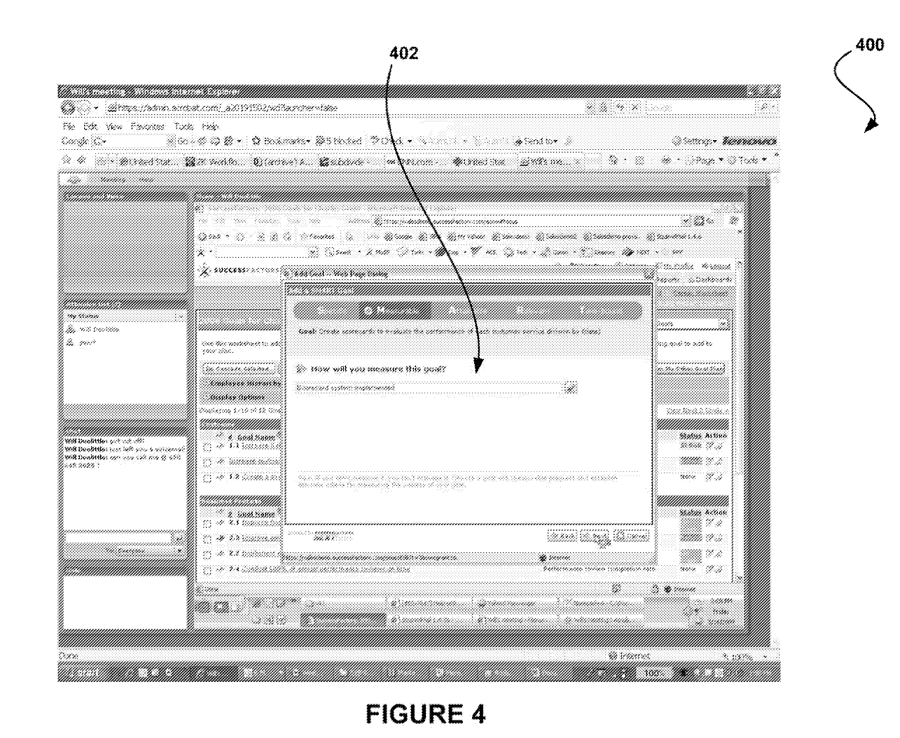

FIG. 4 shows a GUI 400 for receiving information associated with a “measurable” aspect of a goal, in accordance with still yet another embodiment. As an option, the GUI 400 may be implemented in the context of the details of FIGS. 1-3. For example, the GUI 400 may be utilized for receiving information in association with operation 102 of FIG. 1 and/or operations 206, 210, etc. of FIG. 2. Of course, however, the GUI 400 may be implemented in any desired environment. Further, the aforementioned definitions may equally apply to the description below.

As shown, the GUI 400 is a window via which information associated with a “measurable” aspect of a goal may be received. In one embodiment, the information associated with the “measurable” aspect may be input into a field 402 of the GUI 400. For example, a user may type the information associated with the “measurable” aspect into the field 402.

In another embodiment, the information associated with the “measurable” aspect may be selected from a plurality of predefined information associated with “measurable” aspects (not shown). As an option, the predefined information associated with the “measurable” aspects may be associated with particular information associated with a “specific” aspect previously received by the user. For example, the information associated with the predefined “measurable” aspects may be utilized to measure a goal corresponding with the information associated with the “specific” aspect received by the user. Thus, the predefined “measurable” aspects may be particular to the information associated with the “specific” aspect previously received by the user.

Further, the GUI 400 may also include buttons for submitting the information associated with the “measurable” aspect. For example, one of such buttons may be a button for submitting the information associated with a selected “measurable” aspect and progressing to a next GUI.

As yet another option, the GUI 400 may display a description of a general “measurable” aspect. For example, such description may be a tip provided to the user for inputting or selecting the information associated with the “measurable” aspect of the goal. Further, the GUI 400 may also optionally display the information associated with the “specific” aspect previously received from the user. Thus, any information associated with previous aspects received from the user may be displayed via the GUI 400, such that the user may reference such information when inputting or selecting the information associated with the “measurable” aspect.

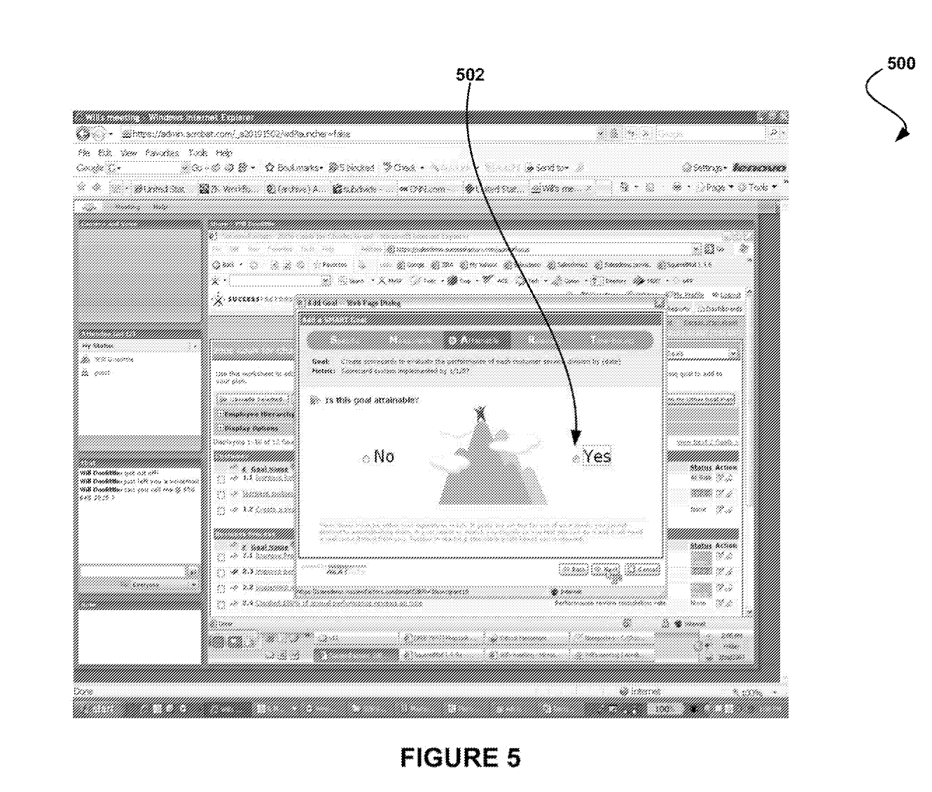

FIG. 5 shows a GUI 500 for receiving information associated with an “attainable” aspect of a goal, in accordance with another embodiment. As an option, the GUI 500 may be implemented in the context of the details of FIGS. 1-4. For example, the GUI 500 may be utilized for receiving information in association with operation 102 of FIG. 1 and/or operations 206, 210, etc. of FIG. 2. Of course, however, the GUI 500 may be implemented in any desired environment. Further, the aforementioned definitions may equally apply to the description below.

The GUI 500 is a window via which information associated with an “attainable” aspect of a goal may be received. As shown, the information associated with the “attainable” aspect may be received utilizing options 502 provided via the GUI 500. For example, the options 502 may include a “yes” option and a “no” option. Thus, the user may be capable of identifying whether the goal is attainable.

Further, the GUI 500 may also include buttons for submitting the information associated with the “attainable” aspect. For example, such buttons may include a button for submitting selected information associated with the “attainable” aspect and progressing to a next GUI.

As yet another option, the GUI 500 may display a description of a general “attainable” aspect. For example, such description may be a tip provided to the user for selecting information associated with the “attainable” aspect of the goal. Further, the GUI 500 may also optionally display any information associated with previous aspects received by a user, such that the user may reference such information when selecting the “attainable” aspect.

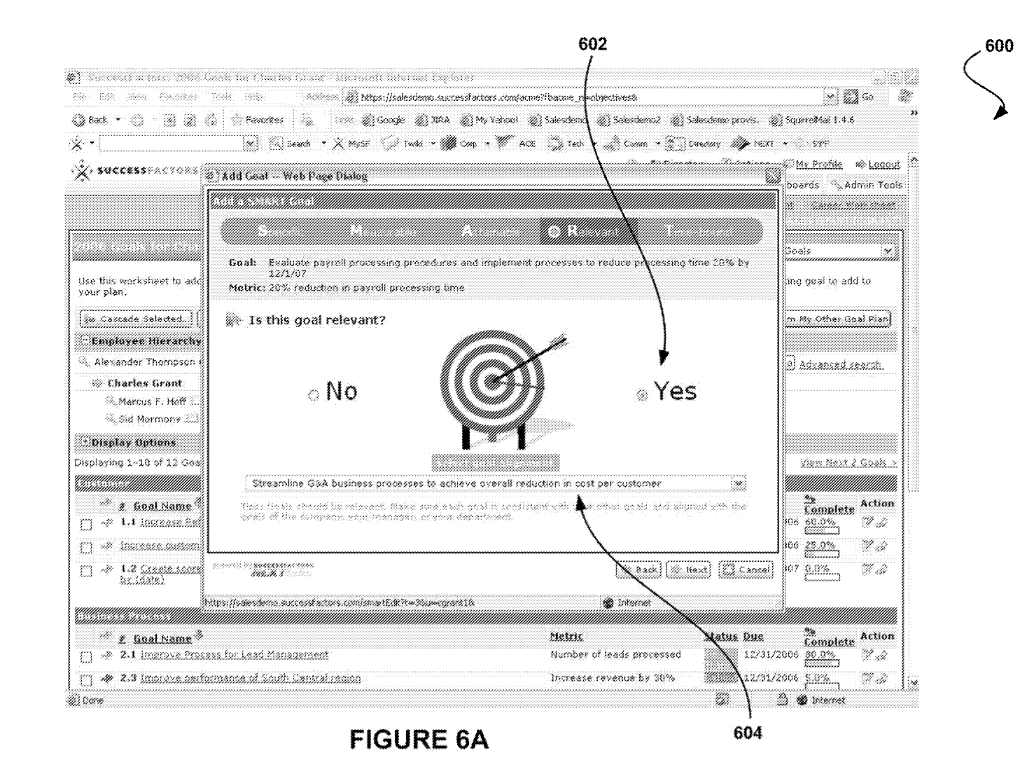

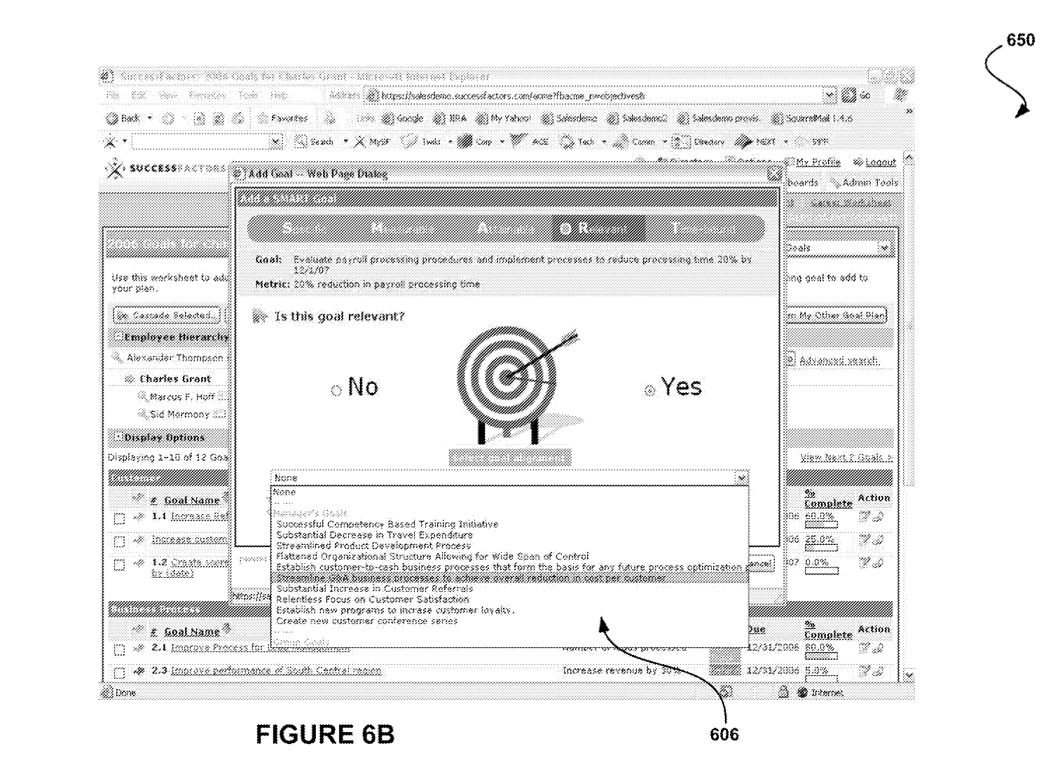

FIG. 6A shows a GUI 600 for receiving information associated with a “relevancy” aspect of a goal, in accordance with yet another embodiment. As an option, the GUI 600 may be implemented in the context of the details of FIGS. 1-5. For example, the GUI 600 may be utilized for receiving information in association with operation 102 of FIG. 1 and/or operations 206, 210, etc. of FIG. 2. Of course, however, the GUI 600 may be implemented in any desired environment. Further, the aforementioned definitions may equally apply to the description below.

The GUI 600 is a window via which information associated with a “relevancy” aspect of a goal may be received. As shown, the information associated with the “relevancy” aspect may be received utilizing options 602 provided via the GUI 600. For example, the options 602 may include a “yes” option and a “no” option. Thus, the user may be capable of identifying whether the goal is relevant.

In addition, the user may also be capable of identifying a different goal to which the goal is relevant. As shown, the other different goal may be input by a user into a “relevancy” aspect field 604. In one embodiment, the other different goal may be typed into the “relevancy” aspect field 604. In another embodiment, the “relevancy” aspect field 604 may be associated with a drop-down list dynamically populated with a plurality of other goals, such as manager's goals, such that the other goal may be selected by the user from the drop-down list of other goals (see item 606 of FIG. 6B, for example).

Further, the GUI 600 may also include buttons for submitting the information associated with the “relevancy” aspect. For example, such buttons may include a button for submitting selected information associated with the “relevancy” aspect and progressing to a next GUI.

As yet another option, the GUI 600 may display a description of a general “relevancy” aspect. For example, such description may be a tip provided to the user for selecting the information associated with the “relevancy” aspect of the goal. Further, the GUI 600 may also optionally display any information associated with previous aspects received by a user, such that the user may reference such information when selecting the information associated with the “relevancy” aspect.

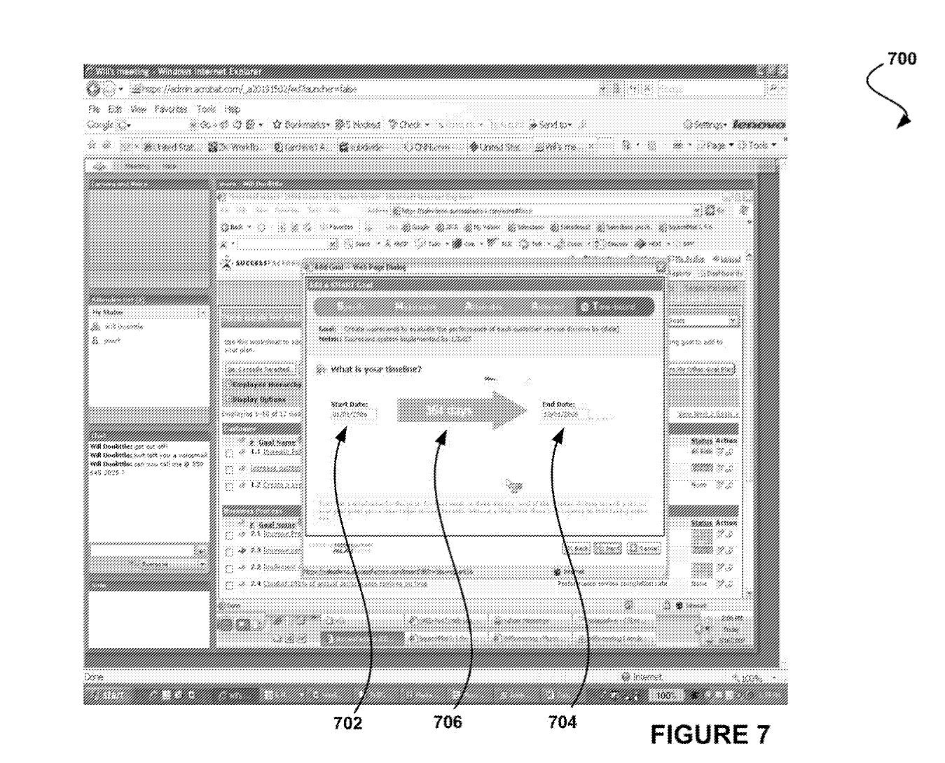

FIG. 7 shows a GUI 700 for receiving information associated with a “time” aspect of a goal, in accordance with still yet another embodiment. As an option, the GUI 700 may be implemented in the context of the details of FIGS. 1-6. For example, the GUI 700 may be utilized for receiving information in association with operation 102 of FIG. 1 and/or operations 206, 210, etc. of FIG. 2. Of course, however, the GUI 700 may be implemented in any desired environment. Further, the aforementioned definitions may equally apply to the description below.

The GUI 700 includes a window via which information associated with a “time” aspect of a goal may be received. As shown, the information associated with the “time” aspect may be received utilizing a start date input field 702 and a completion date input field 704. Thus, the information associated with the “time” aspect may be input by a user. Of course, as another option, the start date and the completion date may be selected by a user utilizing a calendar. In this way, the user may be capable of identifying the information associated with the “time” aspect of the goal.

As also shown, the GUI 700 also includes a dynamic time display 706. The dynamic time display 706 displays a total time calculated from the information associated with the “time” aspect. For example, the dynamic time display 706 is capable of updating dynamically based on the input to the start date input field 702 and the completion date input field 704.

Further, the GUI 700 may also include buttons for submitting the information associated with the “time” aspect. For example, such buttons may include a button for submitting an input “time” aspect and progressing to a next GUI.

As yet another option, the GUI 700 may display a description of a general “time” aspect. For example, such description may be a tip provided to the user for inputting the information associated with the “time” aspect of the goal. Further, the GUI 700 may also optionally display any information associated with previous aspects received by a user, such that the user may reference such information when inputting the “time” aspect.

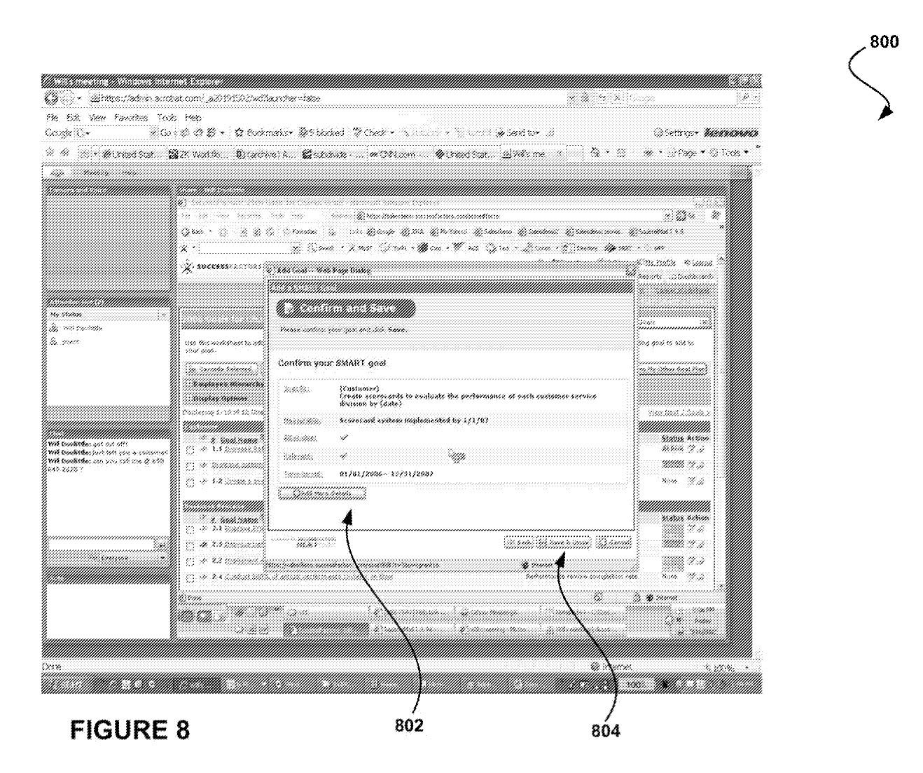

FIG. 8 shows a GUI 800 for prompting the receipt of additional details of a goal, in accordance with another embodiment. As an option, the GUI 800 may be implemented in the context of the details of FIGS. 1-7. Of course, however, the GUI 800 may be implemented in any desired environment. Further, the aforementioned definitions may equally apply to the description below.

The GUI 800 is a window for displaying a summary of information associated with received aspects of a goal. In addition, the GUI 800 includes an add option 802 for adding additional details of the goal. In one embodiment, such additional details may be milestones associated with the goal. In another embodiment, the additional details may be persons to whom the goal is associated (e.g. who are responsible for attaining the goal, etc.).

Further, the GUI 800 includes save button 804 for configuring and saving a goal based on the received information associated with the various aspects. Thus, a user may confirm the displayed summary of the information associated with the aspects of the goal. Also, in response to confirming the summary, the user may select the save button 804 in order to configure and save the goal.

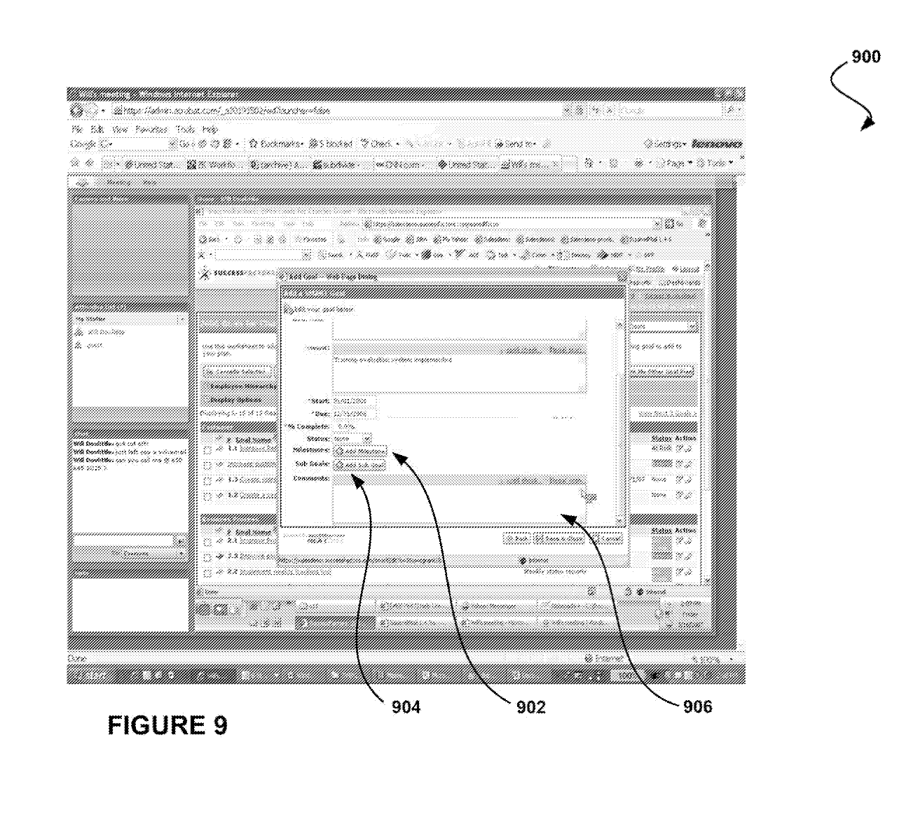

FIG. 9 shows a GUI 900 for receiving additional details of a goal, in accordance with yet another embodiment. As an option, the GUI 900 may be implemented in the context of the details of FIGS. 1-8. For example, the GUI 900 may be displayed in response to a selection of the add option 802 of FIG. 8. Of course, however, the GUI 906 may be implemented in any desired environment. Further, the aforementioned definitions may equally apply to the description below.

As shown, the GUI 900 is a window for allowing a user to input additional details of a goal. In one embodiment, the user may select a milestone button 902 for allowing the user to input at least one milestone associated with the goal. For example, the milestone may include any supporting goals utilized in achieving the goal.

Moreover, the user may select a sub-goal button 904 for allowing the user to input at least one sub-goal associated with the goal. For example, the sub-goal may include a plurality of sub-aspects associated therewith. Optionally, each sub-aspect may include a “specific” aspect, a “measurable” aspect, an “attainable” aspect, a “relevancy” aspect, a “time” aspect, etc. In this way, the goal may be divided into a plurality of sub-goals, each sub-goal including aspects, etc.

As further shown, the GUI 900 may include a comments field 906. Accordingly, the user may be capable of inputting comments associated with the goal. To this end, the comments may be saved in association with the goal.

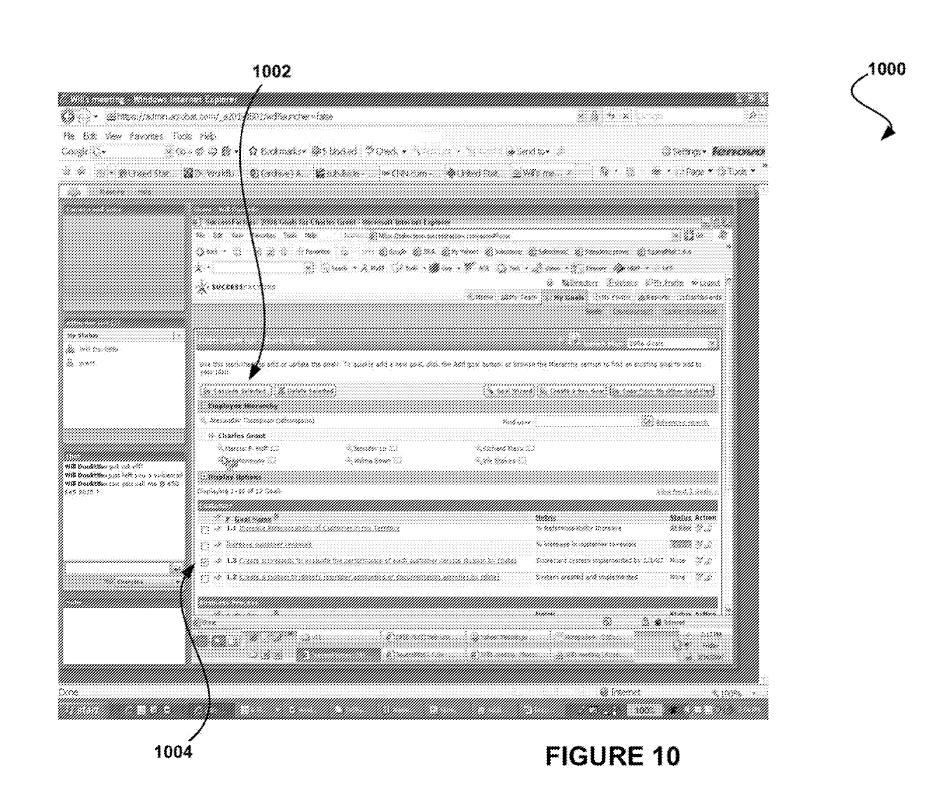

FIG. 10 shows a GUI 1000 for displaying and managing a user's goals, including assigning a goal to a plurality of different people, in accordance with yet another embodiment. As an option, the GUI 1000 may be implemented in the context of the details of FIGS. 1-9. Of course, however, the GUI 1000 may be implemented in any desired environment. Further, the aforementioned definitions may equally apply to the description below.

The GUI 1000 is a window for displaying and managing a user's goals, including allowing a user to assign a configured goal to various people. As shown, the user may select a configured goal 1002. Further, the user may select a cascade option 1004, such that the goal may be assigned to any desired people.

In one embodiment, the goal may be assigned to people selected by the user. Optionally, a search may be performed to find a person for assigning the goal to such person. In another embodiment, the goal may be assigned to people within a group. In yet another embodiment, the goal may be assigned to all available persons.

In another embodiment, the goal may only be assigned to people of lower privileges than the user selecting to assign the goal. For example, a manager may select to assign the goal to the people whom the manager manages. In another embodiment, the goal may be assigned to people of higher privileges that the user selecting to assign the goal. For example, a person may assign the goal to an associated manager. In this way, the goal may be assigned to any persons, such that the persons are responsible for achievement of the goal.

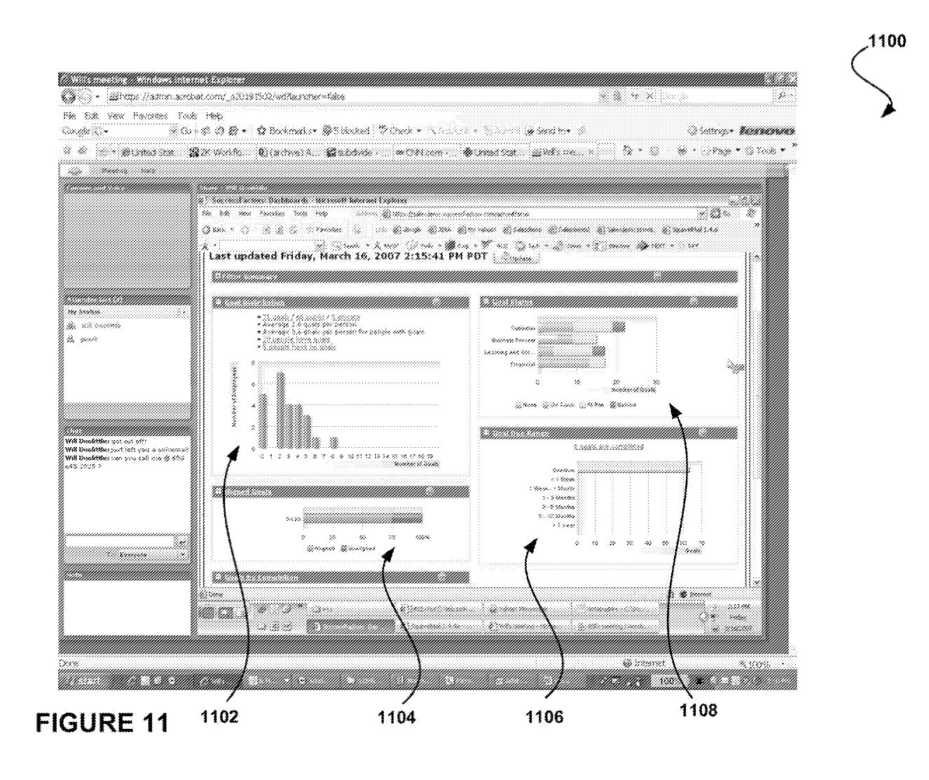

FIG. 11 shows a GUI 1100 for displaying reports associated with a plurality of goals, in accordance with still yet another embodiment. As an option, the GUI 1100 may be implemented in the context of the details of FIGS. 1-10. Of course, however, the GUI 1100 may be implemented in any desired environment. Further, the aforementioned definitions may equally apply to the description below.

The GUI 1100 is a window via which reports may be displayed. As shown, in one embodiment, a total goals report 1102 may include a bar graph showing a number of goals versus a number of employees. Optionally, a summary of the total goals report 1102 may also be displayed. Such summary may include a total number of goals, a number of public goals, a number of private goals, an average number of goals per person, an average number of goals per person for people with assigned goals, a number of people with assigned goals, a number of people without assigned goals, etc.

Additionally, a percentage goals report 1104 may also be displayed. The percentage goals report 1104 may include a bar graph depicting a percentage of goals that are aligned and a percentage of goals that are not aligned. In the context of the present, embodiment, the alignment of goals may include goals that are associated with other goals. Thus, if all goals are associated with other goals, the percentage of alignment may be 100%. For example, a hierarchy of goals may include atop level goal for a company, whereas lower level goals may include goals necessary for achieving the top level goal. Such a hierarchy may represent total alignment of goals.

A categorical goals report 1106 may further be displayed. The categorical goals report 1106 may include a bar graph depicting a number of goals for each category of goals. Moreover, each bar representing a category in the categorical goals report 1106 may further represent a number of goals associated with various statuses. In one embodiment, the statuses may be manually set for each goal. In another embodiment, a status of a particular goal (or any other information about the goal) may only be viewable by a user who has permission to view the goal, according to a role-based permission model.

For example, a particular number of goals within a first category may be on task, at risk, behind, etc. In one embodiment, a goal may be on task if milestones associated with the goal have been completed to date. In another embodiment, a goal may be at risk if a milestone associated with the goal has not yet been completed and the completion date therefore is ending in a predefined number of days (e.g. one day, etc.). In yet another embodiment, the goal may be behind if a milestone associated the goal has not yet been completed and the completion date has therefore passed. In yet another embodiment, the status of a goal may be manually set by the user or automatically set based on a calculation methodology, such as “at risk” if a milestone associated with the goal has not been met.

Moreover, a goals due report 1108 may be displayed. The goals due report 1108 may include a number of goals due for particular categories of time. For example, such categories of time may include overdue, one week, one month, etc. While various reports have been described herein, it should he noted that the GUI 1100 may be capable of displaying any desired reports associated with goals. Further, as an option, the reports may only be displayed to users of predetermined privileges.

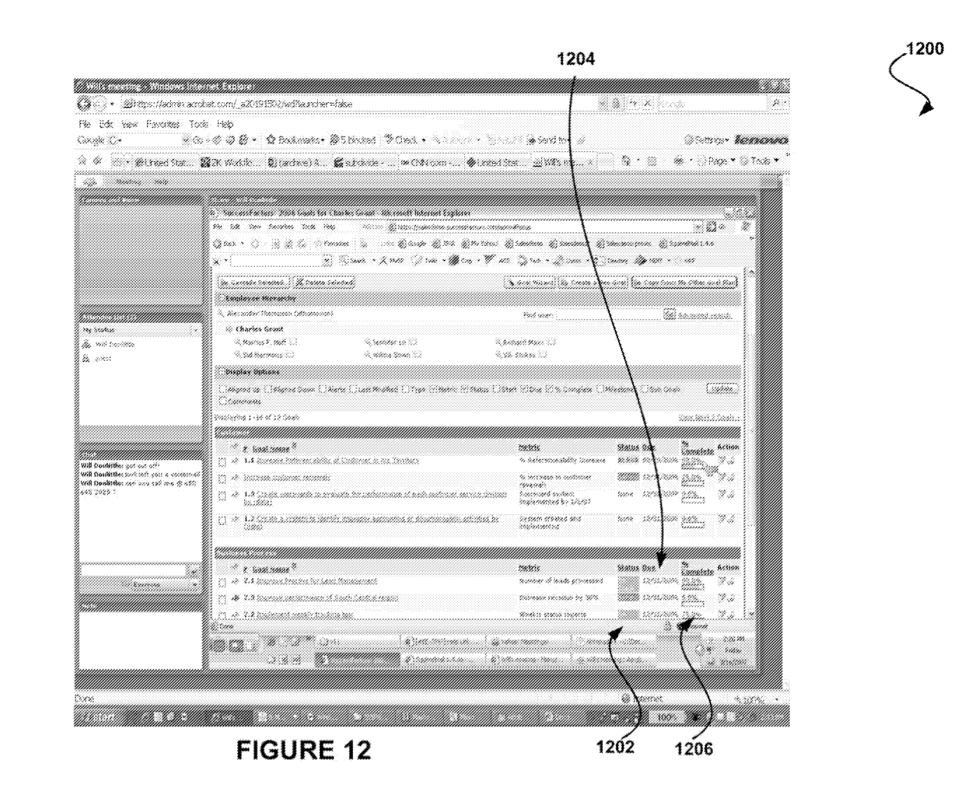

FIG. 12 shows a GUI 1200 for displaying a report associated with each goal, in accordance with another embodiment. As an option, the GUI 1200 may be implemented in the context of the details of FIGS. 1-11. Of course, however, tire GUI 1200 may be implemented in any desired environment. Further, the aforementioned definitions may equally apply to the description below.

As shown, the GUI 1200 is a window for displaying a report for each of a plurality of goals. Each report may display the name of the goal, a “measurable” aspect of die goal, and/or any other desired aspect of the goal. In addition, the report may display a status 1202 of the goal. Such statuses may be user configured, as an option. As another option, the statuses 1202 may include an on track status, an overdue status, etc.

Further, the report may display a due date 1204 of the goal. The due date may be based on a “time” aspect associated with the goal, as an option. Still yet, the report may include a percentage complete value 1206. The percentage complete value 1206 may be based on whether milestones and/or sub-goals associated with the goal have been timely completed as of the current date. It should be noted that the GUI 1200 may be configured to show any desired information associated with the goals.

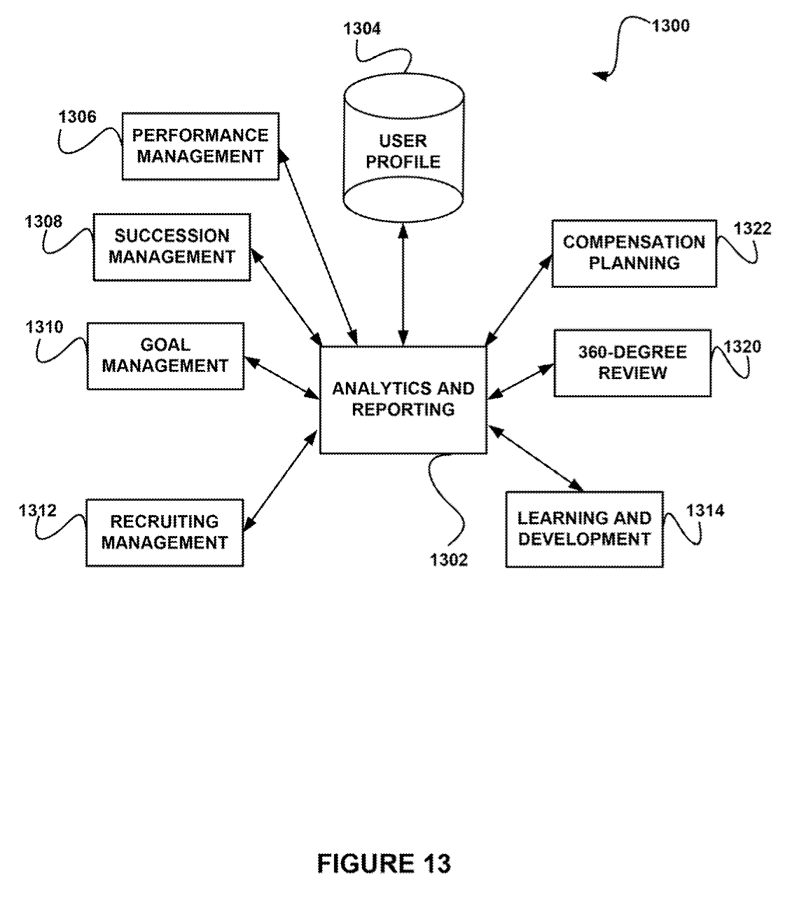

FIG. 13 illustrates a performance and talent management system 1300, in accordance with one embodiment. As an option, the details of FIGS. 1-12 may be implemented in the context of the performance and talent management system 1300. Of course, however, the performance and talent management system 1300 may be implemented in any desired environment. Further, the aforementioned definitions may equally apply to the description below.

The performance and talent management system 1300 includes an analytics and reporting module 1302, as shown. In one embodiment, the analytics and reporting module 1302 may be capable of providing reports. For example, the analytics and reporting module 1302 may receive input from any desired module within the performance and talent management system 1300 and may process such input by arranging the input into a report.

As an option, the analytics and reporting module 1302 may provide reports associated with a performance of a user (e.g. employee, etc.), organization, etc. In various embodiments, such performance may be associated with goal achievement, performance review ratings, compensation, etc. As another option, the analytics and reporting module 1302 may utilize reports to display performance and talent management trends and associated information.

Furthermore, reports displayed via the analytics and reporting module 1302 may include links to underlying input. For example, input utilized in creating a report may he accessed via a link within the report. Moreover, the analytics and reporting module 1302 may also optionally allow reports and/or input to be automatically provided via a spreadsheet, such that additional analysis may he performed.

A user profile module 1304 may also be included within the performance and talent management system 1300. The user profile module 1304 may include profiles associated with a plurality of users. For example, the user profile module 1304 may include a library, database, etc. of all users (e.g. within an organization, etc.).

In one embodiment, the user profile module 1304 may store a page (e.g. web page, etc.) or a link thereto associated with each user. Thus, details of each user may be included within the page. Such details may include, for example, an overall rating, a performance history, a competency rating, a behavior rating, a number of succession nominations, an objectives rating, etc. In still yet other examples, the details may include a summary of prior work experience, education, certificates and licenses, language skills, and/or any other data capable of being associated with a user.

As an option, information within the user profile module 1304 may be secured. For example, access to the information may be restricted to authorized users (e.g. users with associated privileges, etc.). Furthermore, such information may be utilized by the analytics and reporting module 1302 for generating reports associated with the users.

Also included with the performance and talent management system 1300 is a performance management module 1306. The performance management module 1306 may be utilized for creating and reporting on performance reviews associated with user profiles within the user profile module 1304. In use, users may access associated performance reviews via the performance management module 1306.

In one embodiment, the performance management module 1306 may utilize predetermined metrics and standards for creating performance reviews (e.g. via input by a user, etc.). In another embodiment, the performance management module 1306 may automatically distribute review forms and provide users with instant online access to associated performance reviews. Moreover, the performance management module 1306 may include writing and coaching assistants in order to aid users in supplying input for and/or creating performance reviews. The performance management module 1306 may also utilize legal scans to identify and flag inappropriate terminology to avoid potential legal issues.

Still yet, the performance management module 1306 may track performance review progress utilizing reports. Further, a legal scan function may be utilized by the performance management module 1306 for identifying potential legal issues within created performance reviews. As another option, the performance management module 1306 may allow the performance reviews to be distributed in any desired manner.

Further, a 360-degree review module 1320 may be included within the performance and talent management system 1300. The 360-degree review module 1320 may include a 360-degree review capability utilized for allowing reviews to be created based on performance feedback received from a variety of different users, such as self feedback, peer feedback, external feedback, etc. The 360-degree review module 1320 may also identify areas for improvement and development, etc. Further, role-based competencies and behaviors may be utilized in the 360-degree review process. In one embodiment, concise and meaningful reviews may be created using suggested review text previously created by experts.

In addition, a succession management module 1308 may be included within the performance and talent management system 1300. The succession management module 1308 may be utilized for mapping employee positions within an organization. For example, the succession management module 1308 may be utilized to create hiring plans, thus providing users visibility into future employment opportunities associated therewith.

The succession management module 1308 may also determine a strength for each employment position. Further, the succession management module 1308 may track role summaries, skills, competency requirements and readiness ratings for each candidate of a particular employment position. The succession management module 1308 may additionally provide comparisons of candidates featuring relevant information from any applicable modules within the performance and talent management system 1300. Still yet, the succession management module 1308 may utilize the analytics and reporting module 302 for generating reports on employee candidates, by identifying areas for such candidates needing improvement, etc.

Still yet, a goal management module 1310 may be included within the performance and talent management system 1300. In one embodiment, the goal management module 1310 may include a goal wizard similar to that set forth during the description of previous Figures. In use, the goal management module 1310 may synchronize individual user goals with company-wide objectives. The goal management system 1310 may also allow the alignment of goals, such that users may focus on shared goals.

In addition, the goal management module 1310 may allow the achievement progress for each goal to be tracked (e.g. via visual indicators, etc.). Also, the goal management module 1310 may communicate with the performance management module 1306 for allowing users to deliver meaningful feedback based on actual progress of goal achievement. Also, suggestions may be provided via the goal management module 1310 from one user to various other users.

Furthermore, a recruiting management module 1312 may be included within the performance and talent management system 1300. The recruiting management module 1312 may be utilized to automate workflow and identify successful employees. For example, the recruiting management module 1312 may utilize the performance management module 1306 and the succession management module 1310 for identifying characteristics representing a successful user. The identified characteristics may then be utilized to target candidates associated with such characteristics. The recruiting management module 1306 may also have the capability of registering and accepting resumes from applicants over the Internet, as well as from internal applicants.

In one embodiment, the recruiting management module 1312 may be capable of constructing detailed job requisitions. In another embodiment, the goal management module 1310 may automatically move requisitions from a screening phase to an on-boarding phase by collecting required approvals at each phase. Also, approved requisitions may be automatically posted to internal and corporate job sites, professional summary statements may be created describing a business impact of unfilled positions, and pre-screening questions tailored to the organization and the job may be provided into every requisition.

Moreover, a learning and development module 1314 is included within the performance and talent management system 1300. The learning and development module 1314 may be utilized to plan development activities based on both limits in competency and anticipated responsibilities. In addition, an automated advisor may provide relevant direction and support. Still yet, an automated writing assistant may identify suggestions for a desired manner of writing a phrase along with rated recommendations.

The learning and development module 1314 may also utilize legal scans to identify and flag inappropriate terminology to avoid potential legal issues, and may also include an online archive to further maintain a comprehensive audit trail of learning and development plans.

The learning and development module 1314 may be utilized for providing learning opportunities (e.g. training) to users. For example, links may be provided to learning activities. As another example, learning opportunities may be linked directly to a performance review of a user. As another option, the learning and development module 1314 may allow post-learning performance to be reviewed, for example, to determine effectiveness of the learning opportunity. Still yet, learning opportunities may optionally be directly aligned with performance needs and strategic goals.

In addition, a compensation planning module 1322 may be utilized for structuring, evaluating, organizing and implementing a compensation structure. In one embodiment, merit pay, bonuses, and stock may be associated with employee performance. In another embodiment, performance information may be made available via the compensation planning module 1322 when making compensation decisions. In yet another embodiment, market data may be displayed to aid manager decision-making in setting compensation.

Also, automated merit increases may be applied based on guideline calculations such as job level, pay grade, performance rating, comp-ratio, and range penetration. As another option, lump sum adjustments may allow users to move to another pay band using a lump sum adjustment to salary. Further, variable pay may allow overall company or department performance to be taken into account with respect to each individual compensation decision. In addition, management by objectives (MBO) functionality can optionally tie bonus payouts directly to goals and priorities established in the goal management module 1310, as well as ratings established in the performance management module 1306. As yet another option, global offices may be supported with local currencies.

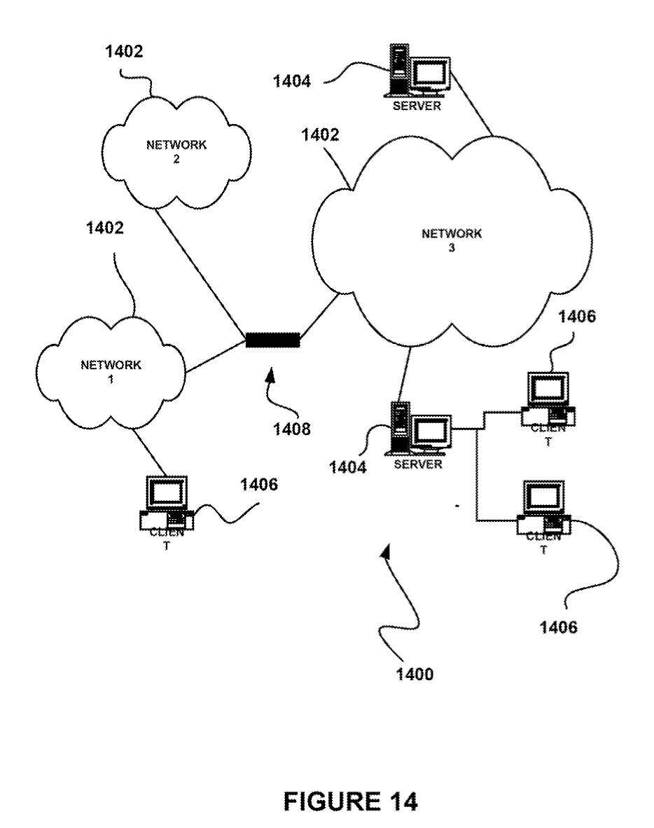

FIG. 14 illustrates a network architecture 1400, in accordance with one embodiment. In one embodiment, the performance and talent management system 1300 of FIG. 13 may be implemented in the context of the network architecture 1400. As shown, at least one network 1402 is provided. In the context of the present network architecture 1400, the network 1402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1402 maybe provided.

Coupled to the network 1402 is a plurality of devices. For example, a server computer 1404 and an end user computer 1406 may be coupled to the network 1402 for communication purposes. Such end user computer 1406 may include a desktop computer, lap-top computer, and/or any other type of logic. Still yet, various other devices may be coupled to the network 1402 including a personal digital assistant (PDA) device 1408, a mobile phone device 1410, a television 1412, etc.

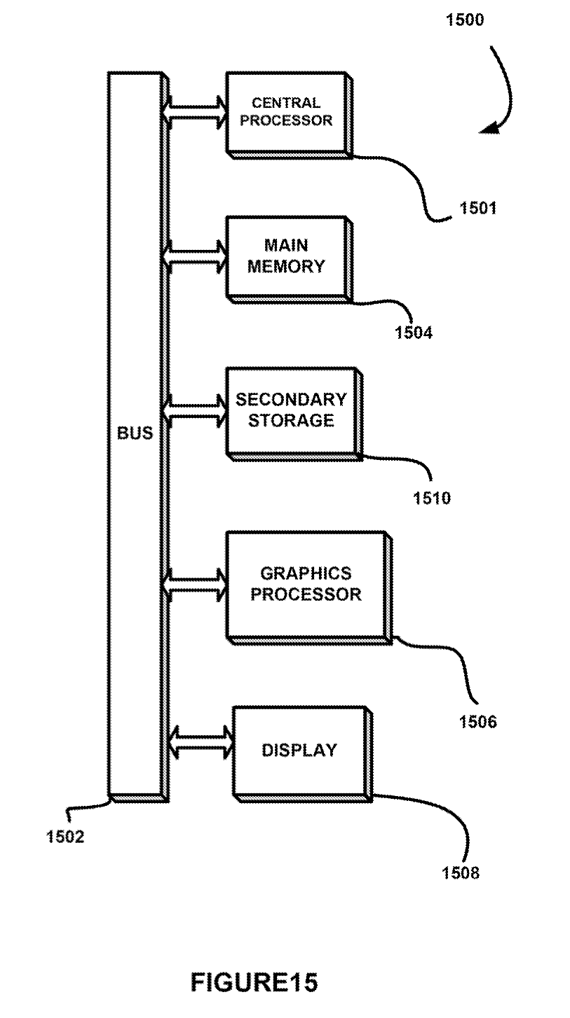

FIG. 15 illustrates an exemplary computer system 1500, in accordance with one embodiment. As an option, the computer system 1500 may be implemented in the context of any of the devices of the network architecture 1400 of FIG. 14. Of course, the computer system 1500 may be implemented in any desired environment.

As shown, a computer system 1500 is provided including at least one central processor 1501 which is connected to a communication bus 1502. The computer system 1500 also includes main memory 1504 [e.g. random access memory (RAM), etc.]. The computer system 1500 also includes a graphics processor 1506 and a display 1508.

The computer system 1500 may also include a secondary storage 1510. The secondary storage 1510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1504 and/or the secondary storage 1510. Such computer programs, when executed, enable the computer system 1500 to perform various functions. Memory 1504, storage 1510 and/or any other storage are possible examples of computer-readable media.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program product embodied on a computer readable medium, comprising:
computer code for receiving information associated with different aspects of a goal utilizing a plurality of graphical user interfaces;
computer code for progressing from a previous one of the graphical user interfaces to a subsequent one of the graphical user interfaces only after receiving the information associated with the previous one of the graphical user interfaces; and
computer code for configuring the goal utilizing the information.

2. The computer program product of claim 1, wherein the aspects include one or more of a specific aspect, a measurable aspect, an attainable aspect, a relevancy aspect, and a time aspect.

3. The computer program product of claim 1, wherein at least one of the aspects includes a specific aspect.

4. The computer program product of claim 3, wherein the information associated with the specific aspect includes a category of the goal.

5. The computer program product of claim 3, wherein the information associated with the specific aspect is received by a user selecting at least one of a plurality of predefined goals.

6. The computer program product of claim 5, wherein the predefined goals are stored in a library.

7. The computer program product of claim 1, wherein at least one of the aspects includes a measurable aspect.

8. The computer program product of claim 7, wherein the information associated with the measurable aspect is utilized by a tool for determining whether the goal is being accomplished.

9. The computer program product of claim 1, wherein at least one of the aspects includes an attainable aspect.

10. The computer program product of claim 9, wherein the information associated with the attainable aspect includes an indication as to whether the goal is attainable.

11. The computer program product of claim 1, wherein at least one of the aspects includes a relevancy aspect.

12. The computer program product of claim 11, wherein the information associated with the relevancy aspect includes an indication as to whether the goal is relevant.

13. The computer program product of claim 12, wherein the goal is relevant if the goal is aligned with another goal.

14. The computer program product of claim 13, wherein the other goal includes a goal of a manager.

15. The computer program product of claim 1, wherein at least one of the aspects includes a time aspect.

16. The computer program product of claim 15, wherein the information associated with the time aspect includes at least one of a start time and a completion time associated with the goal.

17. The computer program product of claim 1, wherein the goal is configured for use with an employee performance and talent management application program.

18. The computer program product of claim 17, wherein the employee performance and talent management application program is web-based.

19. A method, comprising:
receiving information associated with different aspects of a goal utilizing a plurality of graphical user interfaces;
progressing from a previous one of the graphical user interfaces to a subsequent one of the graphical user interfaces only after receiving the information associated with the previous one of the graphical user interfaces; and
configuring the goal utilizing the information.

20. A system, comprising:
an application program for configuring a goal utilizing received information associated with different aspects of the goal;
wherein the aspects include at least one of a specific aspect, a measurable aspect, an attainable aspect, a relevancy aspect, and a time aspect.

21. The system of claim 20, wherein the application program is installed on a server for receiving the information associated with a plurality of the goals from clients over a network.

22. A computer program product embodied on a computer readable medium, comprising:
computer code for receiving information associated with different aspects of a goal, the aspects including at least one of a specific aspect, a measurable aspect, an attainable aspect, a relevancy aspect, and a time aspect; and
computer code for configuring the goal utilizing the information.
